(19) United States
(12) Patent Application Publication
(10) Pub. No.: US 2025/0216631 A1
(43) Pub. Date: Jul. 3, 2025

(54) HIGH-BANDWIDTH FRONT-PLUGGABLE CO-PACKAGED OPTICAL CONFIGURATION FOR DATA CENTER SWITCHING

(71) Applicant: Seagate Technology LLC, Fremont, CA (US)

(72) Inventors: Richard Charles Alexander Pitwon, Letterkenny (IE); Brett R. Herdendorf, Shakopee, MN (US)

(21) Appl. No.: 18/969,688

(22) Filed: Dec. 5, 2024

Related U.S. Application Data
(60) Provisional application No. 63/615,400, filed on Dec. 28, 2023.

(51) Int. Cl. G02B 6/42

(52) U.S. Cl. CPC G02B 6/428; G02B 6/4269

(57) ABSTRACT

Provided are systems, methods and configurations for high-bandwidth co-packaged optical assemblies designed to allow optical modules to be plugged directly into the optical package via slots in the front fascia panel, thus providing for field-replaceability and serviceability of the optical modules while ensuring close electronic connectivity.

### CROSS REFERENCE TO RELATED APPLICATIONS

This application claims the benefit of 63/615,400, filed Dec. 28, 2023, the disclosure of which is incorporated by reference herein in its entirety.

### TECHNICAL FIELD

The disclosure generally relates to high-bandwidth optical configurations and assemblies for data centers.

### SUMMARY

Techniques and systems of the present disclosure generally relate to packaged optical assemblies for use in high-bandwidth switching and processing.

In accordance with certain aspects, an enclosure is provided that defines an inside and that includes a front fascia panel having an inside facing surface and a front facing surface accessible from outside the enclosure. A packaged optical assembly is provided for mounting inside of the enclosure, the packaged optical assembly including a switching or processing chip mounted to a front surface of a mezzanine board. The mezzanine board is mountable to a main printed circuit board inside of the enclosure via a right-angled connector such that a back surface of the mezzanine board is positioned proximate to and substantially parallel with the inside facing surface of the front fascia panel. The mezzanine board and front fascia panel are configured to allow pluggable optical micro-modules to be plugged directly into sockets in the mezzanine board from outside the enclosure through one or more slots in the front fascia panel. Preferably, the pluggable optical micro-modules are optical transceivers, which are interconnect components that transmit and receive data while converting electrical signals to light signals and vice versa.

In certain aspects, the switching or processing chip is an ASIC or FPGA.

In certain aspects, the packaged optical assembly is a high-bandwidth co-packaged optical (CPO) or near-packaged optical assembly (NPO).

In certain aspects, the pluggable optical micro-modules are provided without digital signal processors (DSPs), clock and data recovery (CDR) or other signal conditioning circuitry.

In certain aspects, a heatsink is provided on the packaged optical assembly. Because configurations of the present disclosure can be compact in design, the heatsink can be elongated, and some instances can be far longer than the height of the enclosure, making configurations of the present disclosure more efficient in air-cooled systems.

In certain aspects, the switching or processing chip includes one or more of the following functional modules: a switch, a router, a GPU, a CPU, an XPU, an FPGA, a storage controller, and/or an expander.

In certain aspects, the sockets in the mezzanine board are configured to connect with one or more standard micro-module connectors, such as QSFP, QSFP-DD, and OSFP.

In certain aspects, the pluggable optical micro-modules may include one or more of the following functional components: a laser, a photodiode, a laser driver chip, a transimpedance amplifier chip, a limiting amplifier circuit chip, an optical isolator, and/or a fiber optic connector.

The present disclosure further provides assemblies that include a packaged optical assembly having a switching or processing chip mounted to a front surface of a mezzanine board, where the mezzanine board is configured to allow pluggable optical micro-modules to be plugged directly into sockets in a back surface, and further configured for mounting via a right-angled connector. Right-angle mounting allows the mezzanine board to be vertically oriented with its back surface facing a front fascia panel of an enclosure upon incorporation of the packaged optical assembly into the enclosure.

The details of one or more aspects of the disclosure are set forth in the accompanying drawings and the description below. Other features, objects, and advantages of the techniques described in this disclosure will be apparent from the description and drawings, and from the claims.

### BRIEF DESCRIPTION OF THE DRAWINGS

FIG. 1 is a schematic representation of an assembly for use in high-bandwidth switching and processing in accordance with certain aspects of the present disclosure.

FIGS. 2A and 2B are schematic representations of pluggable optical modules being front plugged into an assembly for use in high-bandwidth switching and processing in accordance with certain aspects of the present disclosure.

FIG. 3(a)-(d) depict schematic representations of different types of currently-implemented optical assemblies and FIG. 3(e) schematically shows an optical assembly in accordance with certain aspects of the present disclosure.

### DETAILED DESCRIPTION

Co-Packaged Optics (CPO) and Near-Packaged Optics (NPO) are currently being implemented to address the burgeoning bandwidth demands of hyperscale data centers, in particular data center switches, which are projected to require bandwidths of 51.2 Tbps in the year 2024, 102.4 Tbps by 2026, and 204.8 Tbps by or shortly after the year 2030. At these bandwidth requirements, front pluggable modules alone will not be able to cope. However, the integration of the corresponding optical engines (OEs) into common ASIC packages such as with CPOs and NPOs also presents considerable challenges on many fronts, including OE design, thermal management, and test and qualification to meet the extremely critical reliability-against-failure criteria. One key challenge will be managing the dense, high-fiber-count chip, board, and system-level optical connections within the CPO package and the host-board.

The co-packaged optics solutions currently being implemented are non-field replaceable, are not serviceable without system shutdown, and are not scalable. On the other hand, front pluggable optics (also referred to herein as faceplate pluggable optics, or FPPs) are field-replaceable and serviceable, although they are unable to accommodate bandwidth requirements without signal integrity issues, and would require digital signal processors and/or signal conditioning components such as signal repeaters, signal re-timers, clock and data recovery circuits, and higher power signal drivers. Moreover, FPPs cannot simply be added ad infinitum to accommodate increasing bandwidth needs since the space on the faceplate is limited.

Currently a 12.8 Tbps switch can be accommodated by 32 400G faceplate pluggable (FPP) transceivers, which fills the faceplate area of a standard 1 RU high enclosure. In order to accommodate a 51.2 Tbps switch with four times the I/O bandwidth of a 12.8 Tbps switch, it is envisaged that sixteen 3.2 Tbps CPO engines will be required with potentially four times the number of fibers at the front faceplate. In addition, most CPO solutions will use an external light source (ELS) to provide the source of continuous wave light to the modulators in the OE, and this ELS module will preferably also be a pluggable module on the faceplate, which will further reduce the available space on the faceplate. The main advantage of CPO solutions is that they enable lower total system power. The use of ELS rather than integrated local lasers in the CPO increases the total system power, thus eliminating the power advantage of CPO over FPP.

The present disclosure describes configurations that provide the performance and other advantages of co-packaged optics with the flexibility of field-replaceable optical modules. In accordance with the present disclosure, systems and arrangements are provided for a high-bandwidth co-packaged optical (CPO) or near-packaged optical assembly (NPO) assembly, including the source ASIC or FPGA (for example, switch ASIC) being mounted on a high density mezzanine board that is in turn mounted on a right angled electrical connector to the main host PCB so that the mezzanine board is arranged vertically with its back surface next to the front fascia of the system enclosure. This configuration allows sockets contained in the mezzanine board to be available for plugging in optical micro-modules directly into the back side of the mezzanine board through slots in the front fascia of the enclosure. Due to the compactness of such an arrangement, the heatsink on the CPO or NPO package can be nearly as long as the depth of the enclosure, which is typically much greater than the height of the enclosure, and thus heat extraction can be more efficient in air-cooled systems.

Reference will now be made to the drawings, which each depict one or more aspects described in this disclosure. However, it will be understood that other aspects not depicted in the drawings fall within the scope of this disclosure. Like numbers used in the figures refer to like components, steps, and the like. However, it will be understood that the use of a reference character to refer to an element in a given figure is not intended to limit the element in another figure labeled with the same reference character. In addition, the use of different reference characters to refer to elements in different figures is not intended to indicate that the differently referenced elements cannot be the same or similar.

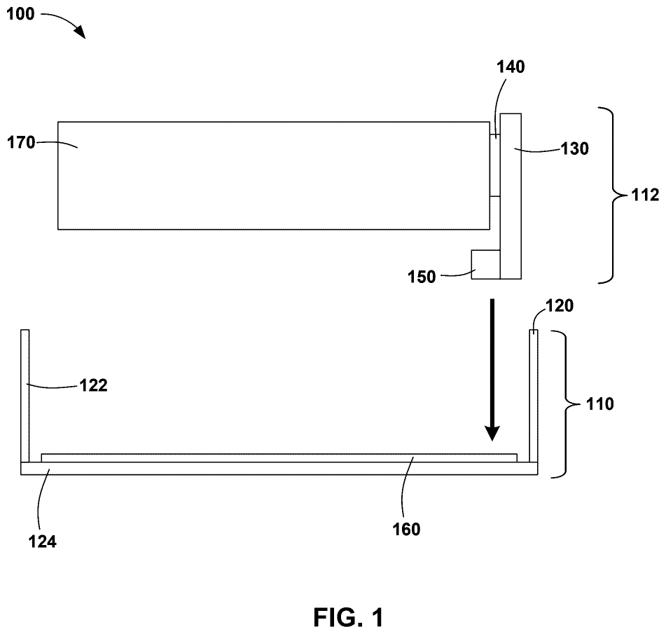

FIG. 1 schematically depicts an assembly 100 for use with high-bandwidth switching and/or processing. Enclosure 110 includes a front fascia panel 120 (also referred to as a faceplate), a bottom panel 124, and an optional back panel 122. A main circuit board 160 is included and may be disposed on the bottom panel 124. While not indicated in the drawings, a small gap exists between the main circuit board 160 and the bottom panel 124, which is maintained with standoffs, to prevent shorting between the metallic bottom panel and the main circuit board. As indicated by the arrow, components including a packaged optical assembly 112 can be mounted inside the enclosure 110. Right-angle connector 150 couples a mezzanine board 130 to the main circuit board 160 (also referred to herein as the system host board). When so attached, the back surface of the mezzanine board 130 is adjacent to and facing the interior surface of the front fascia panel 120. The mezzanine board is a high-density interconnect board. A chip 140 such as an ASIC or FPGA for switching and/or processing is coupled to the front surface of the mezzanine board 130. Chip 140 may include the following functional modules: switch, router, GPU, CPU, XPU, FPGA, storage controller, expander, and so forth.

Optionally, a heatsink 170 is provided on packaged optical assembly 112. Because of the vertical configuration of the mezzanine board 130 and switching/processing chip 140, there may be substantial room within the enclosure 110 for heatsink 170 to be extended, thereby increasing the cooling efficiency within the enclosure. While FIG. 1 is schematic and not meant to be a scale drawing, it is contemplated that the heatsink 170 may be elongated to have a long dimension that is substantially larger than the height of the enclosure 110, for example twice as long as the height of the enclosure (where the enclosure height is determined by the vertical dimension of the front fascia panel).

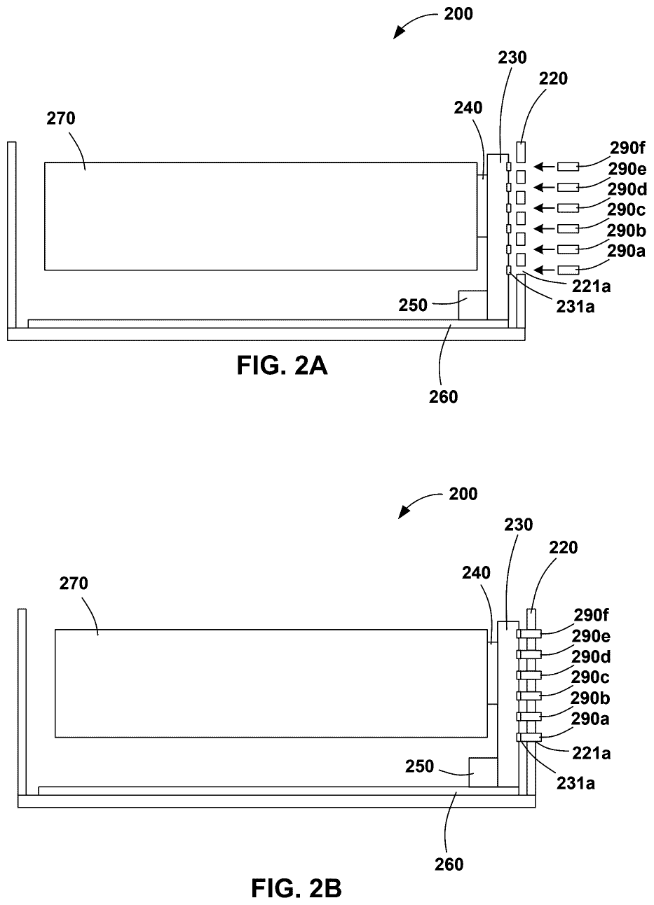

FIGS. 2A and 2B schematically depict an assembly 200 in accordance with the present disclosure. FIG. 2A shows the assembly 200 with optical micro-modules 290a-290f unplugged, and FIG. 2B shows the assembly 200 with optical micro-modules 290a-290f plugged into sockets arranged in the back surface of mezzanine board 230. All reference numerals in FIGS. 2A and 2B are the same and indicate the same components and features.

Mezzanine board 230 is coupled to system board 260 via right-angle connector 250 so that the mezzanine board is substantially parallel to front fascia panel 220 with its back surface proximate to and facing the interior surface of the front fascia panel 220. The mezzanine board includes sockets such as socket 231a for plugging in optical micro-modules such as micro-module 290a through slots in the front fascia panel 220 such as slot 221a. The optical micro-modules are optical transceivers, which are interconnect components that transmit and receive data while converting electrical signals to light signals and vice versa.

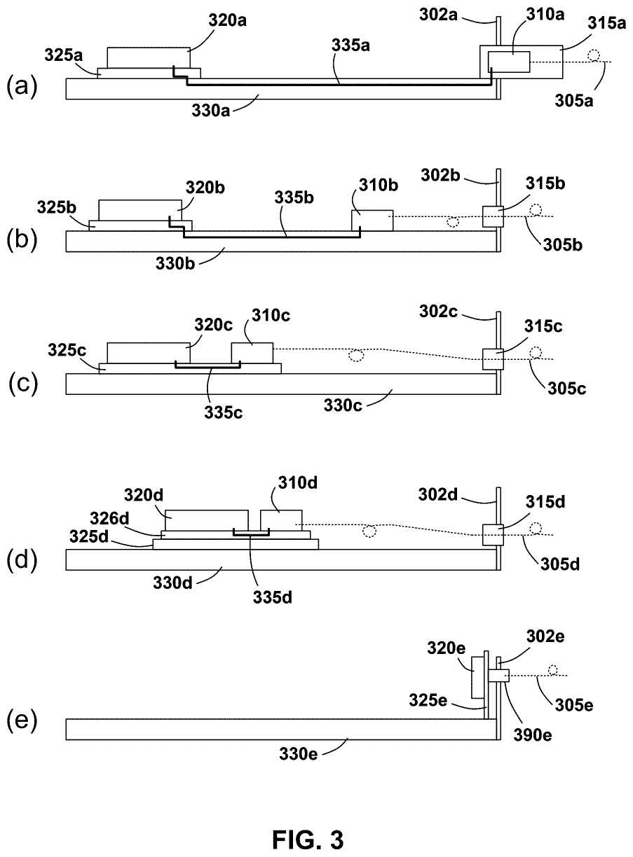

Because the optical micro-modules 290a-290f plug directly into the mezzanine board 230, the path-length for high-speed electronic signals conveyed between the chip 240 and the micro-modules 290a-290f will be minimized, being nearly as short as would be expected in a traditional CPO assembly. This can help ensure minimal signal degradation even at very high electronic symbol rates, including for example 56 GBaud, 112 GBaud, and 240 GBaud. This further allows the optical micro-modules to dispense with signal conditioning circuitry that would normally be included, such as DSP, CDR and signal repeaters and signal re-timers, thereby reducing the power consumption of the modules substantially, for example by 50% compared to traditional FPPs that require signal conditioning circuitry to compensate for electronic signal deterioration over longer electronic path lengths. In addition, such configurations also remove the requirement for intermediary fiber links within the enclosure that are present in CPO or NPO assemblies (see, for example, FIG. 3(b)-(d)).

While the micro-module transceivers do not require DSPs or similar signal-conditioning circuitry, the micro-modules can include functional components such as the following: lasers, photodiodes, laser driver chips, transimpedance amplifier chips, limiting amplifier circuits chips, optical isolators, fiber optic connectors.

The sockets in the mezzanine board for accepting the optical micro-modules can be configured to connect with any suitable optical micro-module connectors such as QSFP, QSFP-DD, and OSFP, as well as new smaller form factors of optical micro-module that are enabled by removal of the signal conditioning circuitry.

Processing and/or switching chip 240 is coupled to the front surface of the mezzanine board 230. Chip 240 may include the following functional modules: switch, router, GPU, CPU, XPU, FPGA, storage controller, expander.

FIG. 3 schematically compares existing optical assemblies (a)-(d) with an optical assembly configuration in accordance with the present disclosure (e).

In FIG. 3(a), an example of a front pluggable optics configuration is indicated. Fiber optics 305a are attached to a faceplate pluggable (FPP) module 315a plugged into a slot in the faceplate 302a. FPP module 315a includes an optical module 310a that converts optical signals to electronic signals and electrical signals into optical signals. Optical module 310a typically includes an optical transceiver engine along with signal conditioning elements including a DSP, CDR, signal re-timers and signal repeaters. Representative commercially available optical modules include QSFP, QSFP-DD, and OSFP. Electrical and electronic signals are transmitted via conductive signal path 335athat connects FPP module 315a to switch package 320a that is connected to a system board 330a via substrate 325a. The system board is typically a printed circuit board.

In FIG. 3(b), an example of an optics on board (OBO) configuration is indicated. In this case, plug 315b in faceplate 302b merely connects fiber optics 305b to an optical module 310b inside the enclosure, which includes an optical transceiver engine. The optical module 310b is coupled to a system board 330b. Switch package 320b is connected to the system board 330b through substrate 325b. The signal path 335b from the optical module 310b to the switch package 320b runs through the system board 330b.

In FIG. 3(c), an example of a co-packaged optics (CPO) configuration is indicated. As in FIG. 3(b), plug 315c in faceplate 302c connects fiber optics 305c to an optical module 310c inside the enclosure, which includes an optical transceiver engine. In this case, the optical module 310c resides on the same substrate 325c as the chip package 320c. Thus, the optical module 310c is connected to the chip package 320c via substrate 325c and the chip package 320c is connected to the system board 330c through the substrate 325c. Substrate 325c can be a high-performance RF substrate that provides a better impedance match and reduces loss of electrical signal. This allows signal path 335c from the optical module 310c to the switch package 320c to route through the substrate 325c rather than the system board 330c.

In FIG. 3(d), an example of a near-packaged optics (NPO) configuration is indicated. Plug 315d in faceplate 302d connects fiber optics 305d to an optical module 310d inside the enclosure, which includes an optical engine. In this case, the optical module 310d is packaged together with chip package 320d, as indicated by both componets residing on package substrate 326d. The package including optical module 310d, switch package 320d, and substrate 326d is connected to the system board 330d through a mezzanine circuit board 325d. Mezzanine circuit board 325d can be a high-performance RF substrate that provides a better impedance match and reduces loss of electrical signal. The signal path 335d from the optical module 310d to the switch package 320d is thus contained entirely within the combined chip and optics package.

In CPO configurations such as shown in FIG. 3(c) and NPO configurations such as shown in FIG. 3(d), the optics and chip modules are not interconnected through the system board in order to increase performance and reduce cost. NPOs and CPOs instead use a high-value RF substrate as the co-packaging platform for the chip and the optical engine, which helps to reduce the deterioration of high frequency electrical signals. In NPO configurations, the chip is packaged, thus containing a die and packaging substrate, for example ASIC packaging substrate. In NPO configurations, the optical transceiver engine is packaged separately, but is mounted in close proximity to the chip on a common mezzanine circuit board. In many CPO and NPO configurations, a DSP is still needed on the chip to provide signal conditioning to high frequency signals going to and coming from the optical module, however a DSP is not typically required in the optical module. CPO configurations can be evolved to remove the outer package of the independently packaged switch chip and directly connect the part of the optical engine with a die. CPO configurations can be further evolved to remove the outer package of the independently packaged chip and directly connect the part of the optical engine with the die. The optical engine can be a packaged module or a complete chip that include a silicon photonics module, electrical modules, and in some cases a laser.

In the on-board optical (OBO), near-packaged optical (NPO) and co-packaged optical (CPO) configurations shown in FIG. 3(b)-(d), the optical modules are non-field replaceable, not scalable, and not serviceable at all or not serviceable without a full system shutdown and partial disassembly. On the other hand, the optical transceiver modules in an FPP configuration shown in FIG. 3(a) are completely field-replaceable and serviceable, but this configuration is limited by the signal frequency of electronic signals conveyed between chip and optical modules at the front fascia and the path length between them by the physical deterioration of high frequency electronic signals (e.g., greater than 100 GBaud) along conductive paths including many centimeters of PCB traces and over multiple electronic pad transitions. While there are effective methods to mitigate signal degradation, including adding DSPs and other signal conditioning circuitry and driving electrical signals with higher signal amplitude in the FPPs and along the intermediary signal path itself, these measures increase system power and cost. Moreover, there will be a limit to the number of modules that can fit along the front fascia arranged to connect to a single board edge.

These drawbacks of known configurations can be addressed by utilizing configurations in accordance with the present disclosure. For example, FIG. 3(e) shows a configuration in which a front pluggable optical micro-module 390e connects fiber optics 305e to the switching package 320e by plugging directly into the board 325e that connects the chip package 320e to the main system board 330e. Slots in the faceplate 302e allow micro-modules 390e to be plugged into sockets in back of the mezzanine board 325e of the chip package 320 from the front of the enclosure. This configuration allows the optical modules to be field-replaceable and serviceable without system shutdown, while also creating a direct connection between the optical engine and the chip package to thereby reduce signal degradation.

Arrangements of the present disclosure also address the aforementioned limit to the number of micro-modules that can fit in the front fascia in typical FPP configurations. In assemblies of the present disclosure, the possible number of micro-modules is greatly expanded due to the vertical arrangement that allows the full area of the front fascia to be used, owing to the fact that the micro-modules are not connecting to one edge of a co-planar card, but rather to an orthogonal plane. Also, since the micro-modules can be stripped of signal conditioning circuitry due to their very close proximity to the chip, new and smaller streamlined form factors of transceiver modules are enabled, such as linear drive optical modules, thereby allowing more modules to fit into the area of the front fascia.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules.

All scientific and technical terms used herein have meanings commonly used in the art unless otherwise specified. The definitions provided herein are to facilitate understanding of certain terms used frequently herein and are not meant to limit the scope of the present disclosure.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

As used herein, the term “configured to” may be used interchangeably with the terms “adapted to” or “structured to” unless the content of this disclosure clearly dictates otherwise.

As used herein, the term “or” refers to an inclusive definition, for example, to mean “and/or” unless its context of usage clearly dictates otherwise. The term “and/or” refers to one or all of the listed elements or a combination of at least two of the listed elements.

As used herein, the phrases “at least one of” and “one or more of” followed by a list of elements refers to one or more of any of the elements listed or any combination of one or more of the elements listed.

As used herein, the terms “coupled” or “connected” refer to at least two elements being attached to each other either directly or indirectly. An indirect coupling may include one or more other elements between the at least two elements being attached. Further, in one or more embodiments, one element “on” another element may be directly or indirectly on and may include intermediate components or layers therebetween. Either term may be modified by “operatively” and “operably,” which may be used interchangeably, to describe that the coupling or connection is configured to allow the components to interact to carry out described or otherwise known functionality. For example, a controller may be operably coupled to a resistive heating element to allow the controller to provide an electrical current to the heating element.

As used herein, any term related to position or orientation, such as “proximal,” “distal,” “end,” “outer,” “inner,” and the like, refers to a relative position and does not limit the absolute orientation of an embodiment unless its context of usage clearly dictates otherwise.

The singular forms “a,” “an,” and “the” encompass embodiments having plural referents unless its context clearly dictates otherwise.

As used herein, “have,” “having,” “include,” “including,” “comprise,” “comprising” or the like are used in their open-ended sense, and generally mean “including, but not limited to.” It will be understood that “consisting essentially of,” “consisting of,” and the like are subsumed in “comprising,” and the like.

Reference to “one embodiment,” “an embodiment,” “certain embodiments,” or “some embodiments,” etc., means that a particular feature, configuration, composition, or characteristic described in connection with the embodiment is included in at least one embodiment of the disclosure. Thus, the appearances of such phrases in various places throughout are not necessarily referring to the same embodiment of the disclosure. Furthermore, the particular features, configurations, compositions, or characteristics may be combined in any suitable manner in one or more embodiments.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

What is claimed is:

1. An assembly for use in high-bandwidth switching and processing, the assembly comprising:
an enclosure defining an inside and comprising a front fascia panel having an inside facing surface and a front facing surface accessible from outside the enclosure;
a packaged optical assembly inside of the enclosure, the packaged optical assembly including a switching or processing chip mounted to a front surface of a mezzanine board; and
a main printed circuit board inside of the enclosure, the mezzanine board being mounted to the main printed circuit board via a right-angled connector so that a back surface of the mezzanine board is positioned proximate to and substantially parallel with the inside facing surface of the front fascia panel, the mezzanine board and front fascia panel being configured to allow pluggable optical micro-modules to be plugged directly into sockets in the mezzanine board through from outside the enclosure through one or more slots in the front fascia panel.

2. The assembly of claim 1, further comprising a heatsink disposed to remove heat from the packaged optical assembly during operation, the heatsink being elongated in a direction substantially perpendicular to the front fascia panel.

3. The assembly of claim 2, wherein the heatsink has a length in the elongated direction that is more than twice a height of the enclosure.

4. The assembly of claim 1, wherein the packaged optical assembly is a co-packaged optical assembly (CPO).

5. The assembly of claim 1, wherein the packaged optical assembly is a near-packaged optical assembly (NPO).

6. The assembly of claim 1, wherein the switching or processing chip is an ASIC.

7. The assembly of claim 1, wherein the switching or processing chip is an FPGA.

8. The assembly of claim 1, wherein the switching or processing chip includes one or more of the following functional modules: a switch, a router, a GPU, a CPU, an XPU, an FPGA, a storage controller, and/or an expander.

9. The assembly of claim 1, wherein the sockets in the mezzanine board are configured to connect with one or more standard micro-module connectors.

10. The assembly of claim 9, wherein the standard micro-module connectors include at least one of QSFP, QSFP-DD, and OSFP.

11. The assembly of claim 1, wherein the pluggable optical micro-modules are optical transceivers.

12. The assembly of claim 1, wherein the pluggable optical micro-modules are provided without signal conditioning circuitry.

13. The assembly of claim 1, wherein the pluggable optical micro-modules are provided without digital signal processors (DSPs).

14. The assembly of claim 1, wherein the pluggable optical micro-modules include one or more of the following functional components: a laser, a photodiode, a laser driver chip, a transimpedance amplifier chip, a limiting amplifier circuit chip, an optical isolator, and/or a fiber optic connector.

15. An assembly for use in high-bandwidth switching and processing, the assembly comprising:
a packaged optical assembly including a switching or processing chip mounted to a front surface of a mezzanine board, the mezzanine board configured to allow pluggable optical micro-modules to be plugged directly into sockets in a back surface of the mezzanine board,
wherein the mezzanine board is further configured for mounting via a right-angled connector so that a back surface of the mezzanine board can be vertically oriented and facing a front fascia panel of an enclosure upon incorporation of the packaged optical assembly in the enclosure.
